(19) United States
(12) Patent Application Publication
(10) Pub. No.: US 2020/0302672 A1
(43) Pub. Date: Sep. 24, 2020

(54) COMPUTERIZED RENDERING OF ANIMATED OBJECTS USING POLYNOMIAL PARTICLE-IN-CELL METHOD

(71) Applicant: THE REGENTS OF THE UNIVERSITY OF CALIFORNIA, Oakland, CA (US)

(72) Inventors: Joseph M. TERAN, Los Angeles, CA (US); Chenfanfu JIANG, Los Angeles, CA (US); Theodore F. GAST, Los Angeles, CA (US); Chuyuan FU, Los Angeles, CA (US); Qi GUO, Los Angeles, CA (US)

(73) Assignee: THE REGENTS OF THE UNIVERSITY OF CALIFORNIA, Oakland, CA (US)

(21) Appl. No.: 16/753,260

(22) PCT Filed: Oct. 8, 2018
(86) PCT No.: PCT/US2018/054879

§ 371 Date: Apr. 2, 2020

Related U.S. Application Data
(60) Provisional application No. 62/569,970, filed on Oct. 9, 2017.

(51) Int. Cl. G06T 13/80; G06F 30/20

(52) U.S. Cl. CPC G06T 13/80; G06F 2111/10; G06T 2210/56; G06F 30/20

(57) ABSTRACT

A method of rendering an animated object includes: (1) determining momentums of a plurality of particles of the object as sums of polynomials; (2) transferring the momentums of the particles of the object to a grid including a plurality of grid nodes; (3) updating momentums of the grid nodes based on the transferred momentums of the particles; (4) transferring the updated momentums of the grid nodes to the particles of the object; (5) updating positions of the particles based on the updated momentums of the grid nodes; and (6) outputting a visualization of the object based on the updated positions of the particles of the object.

### CROSS-REFERENCE TO RELATED APPLICATION

This application claims the benefit of U.S. Provisional Application No. 62/569,970, filed Oct. 9, 2017, the contents of which are incorporated herein by reference in their entireties.

### STATEMENT REGARDING FEDERALLY SPONSORED RESEARCH OR DEVELOPMENT

This invention was made with government support under W81XWH-15-1-0147, awarded by the U.S. Army, Medical Research and Materiel Command, 1422795, awarded by the National Science Foundation, and N00014-11-1-0719, and N00014-12-1-0834, awarded by the U.S. Navy, Office of Naval Research. The government has certain rights in the invention.

### TECHNICAL FIELD

The present disclosure relates to physically based animation, and more particularly to a computerized simulation of 3-dimensional (3D) objects.

### BACKGROUND

Physically based animation is used to simulate physically plausible behaviors of objects. The techniques of physically based animation are particularly concerned with physical plausibility, numerical stability, and visual appeal of the objects being simulated or animated. The techniques of physically based animation include simulations of, for example, rigid bodies (e.g., metal objects, rocks), soft bodies (e.g., muscle, fat, hair, vegetation, clothing, fabric), fluid (e.g., water), particles (e.g., smoke, fire, moving water, cloud, snow, dust, stars), as well simulations of complex behaviors of various objects (e.g., humans, animals, plants, clothing, etc.) and interactions between objects.

### SUMMARY

In some embodiments, a method of rendering an animated object includes: (1) determining momentums of a plurality of particles of the object as sums of polynomials; (2) transferring the momentums of the particles of the object to a grid including a plurality of grid nodes; (3) updating momentums of the grid nodes based on the transferred momentums of the particles; (4) transferring the updated momentums of the grid nodes to the particles of the object; (5) updating positions of the particles based on the updated momentums of the grid nodes; and (6) outputting a visualization of the object based on the updated positions of the particles of the object.

In additional embodiments, a non-transitory computer-readable storage medium stores a program to render an animated object, and the program includes instructions executable by a processor to: (1) represent the object using a plurality of particles; (2) transfer momentums of the particles to a grid representation of the object, the grid representation including a plurality of grid nodes; (3) update momentums of the grid nodes based on the transferred momentums of the particles; (4) transfer the updated momentums of the grid nodes to the particles, by interpolation of mass-orthogonal polynomial velocity modes; (5) determine updated positions of the particles based on the transferred momentums of the grid nodes; and (6) update a visualization of the object based on the updated positions of the particles.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

Aspects of the present disclosure are best understood from the following detailed description when read with the accompanying drawings. It is noted that various features may not be drawn to scale, and the dimensions of the various features may be arbitrarily increased or reduced for clarity of discussion.

FIG. 1 illustrates a process of updating the Lagrangian state of particles of an object and updating grid momentums.

FIG. 2 illustrates a sample process of grid interpolation.

FIG. 3 illustrates component-wise velocity modes.

FIG. 4 illustrates mapping approximations for updating Lagrangian.

FIG. 5 illustrates a Table 1 showing an unmodified sparsity pattern.

FIG. 6 illustrates a Table 2 showing a modified sparsity pattern.

FIG. 7 illustrates a simulation of vortex sheets.

FIG. 8 illustrates a simulation of an ink droplet in an ambient incompressible fluid by dropping liquid onto a free surface.

FIG. 9 illustrates a three-dimensional (3D) simulation of a rotating column of colored dust.

FIG. 10 illustrates a simulation of sand demonstrating an increasingly energetic nature of elastoplasticity simulations with disclosed polynomial modes.

FIG. 11 illustrates an improved energy conservation of the disclosed method.

FIG. 12 illustrates how increased energy retention affects the dynamics of a jello dropped on a ground.

FIG. 13 is a high-level block diagram illustrating an example of a hardware architecture of a computing device that may perform various processes as disclosed.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

Various embodiments of the present disclosure are discussed in detail below. It should be appreciated, however, that the embodiments set forth many applicable concepts that can be embodied in a wide variety of specific contexts. It is to be understood that the following disclosure provides many different embodiments or examples of implementing different features of various embodiments. Specific examples of components and arrangements are described below for purposes of discussion. These are, of course, merely examples and are not intended to be limiting.

Embodiments, or examples, illustrated in the drawings, are disclosed below using specific language. It will nevertheless be understood that the embodiments and examples are not intended to be limiting. Any alterations and modifications of the disclosed embodiments, and any further applications of the principles disclosed in this disclosure, as would normally occur to one of ordinary skill in the pertinent art, fall within the scope of this disclosure.

In addition, the present disclosure may repeat reference numerals and/or letters in the various examples. This repetition is for the purpose of simplicity and clarity and does not in itself dictate a relationship between the various embodiments and/or configurations discussed.

According to at least some embodiments of the present disclosure, a computerized simulation method of visualizing 3D objects is described. An object to be simulated and visualized is represented as including a plurality of particles. To simulate the motions of the object, a grid including a plurality of grid nodes is used to represent the object. The momentums of object particles are transferred to the grid nodes. Based on the transferred momentums, the momentums of the grid nodes are updated. Using a polynomial particle-in-cell method, the updated momentums of the grid nodes are transferred back to the object particles. Thus, the positions and motions of the particles of the 3D object are visualized based on the updated momentums.

According to at least some embodiments of the present disclosure, the disclosed polynomial particle-in-cell method (also referred to as disclosed method or disclosed technology) augments each particle with a general local function. By representing the grid-to-particle transfer as a linear and angular momentum conserving projection of the particle-wise local grid velocities onto a reduced basis, the method improves energy and vorticity conservation. Furthermore, the extra cost of the generalized projection is negligible when using a particular class of local polynomial functions. The method retains the filtering property and achieves a good ratio of robustness to noise.

### 1. INTRODUCTION

In some embodiments, simulation techniques for natural phenomena in computer graphics applications accommodate a wide range of geometric domains and material behaviors. In some embodiments, Lagrangian techniques resolve transport phenomena and allow for streamlined rendering of the phenomena; in addition, Eulerian techniques resolve topology change and contact or collision. In some embodiments, particle-in-cell (PIC) is a hybrid approach attempting to attain the benefits of both Lagrangian and Eulerian views. In PIC, particles store a primary state such as mass and momentum. However, the effect of internal stress on momentum is added on an Eulerian grid. This is reconciled by transfers back and forth between the particles and grid. There may be a mismatch in the number of particle and grid degrees of freedom which may lead to errors during the frequent transfers between representations of particles and grid nodes.

In some embodiments, the PIC possesses a stabilizing filter property since particle velocities are interpolated from the grid after the stress response. However, this may lead to excessive dissipation since particle modes are essentially overwritten by the generally lower resolution grid. In some embodiments, Fluid-Implicit-Particle (FLIP) removes the constraint by interpolating increments in velocity rather than velocity itself as in PIC. However, this means that particle modes invisible to the grid persist despite not receiving a meaningful constitutive response. This can lead to particle artifacts such as noise, instability, clumping and volume loss/gain. In some embodiments, an affine particle-in-cell (APIC) approach attempts to prevent these artifacts, without incurring the excessive dissipation of PIC. APIC retains the filtering property, but addresses dissipation by interpolating more information from the grid to the particles. By allowing particles to store both velocity and velocity derivative information, the transfers between particles and grid conserve angular momentums and generally attain the benefits of both PIC and FLIP.

According to at least some embodiments of the present disclosure, the disclosed method allows for locally polynomial, rather than locally affine approximations to the grid velocity field. The disclosed method may be referred to as polynomial particle-in-cell or PolyPIC. The generalization of PolyPIC improves kinetic energy conservation during transfers which leads to better vorticity resolution in fluid simulations and less numerical damping in elastoplasticity simulations. The grid-particle transfers are designed to select particle-wise polynomial approximations to the grid velocity that are optimal in the local mass-weighted L² norm. This may correspond to a reduced basis APIC derivation for affine modes, but generalized to polynomial modes. The transfers of the disclosed method reproduce the original PIC if constants are used and APIC if affine polynomials are used. The polynomial basis of the disclosed method is mass-orthogonal to facilitate rapid solution of the optimality condition. By design, this reduces the projection to the polynomial basis to the solution of a diagonal linear system of size equal to the number of local polynomial modes. This has the additional benefit of simplifying applications with staggered grids.

Thus, according to at least some embodiments of the present disclosure, characteristics of the disclosed method include one or more of: (1) generalization from locally affine to locally polynomial representations that improve kinetic energy conservation in particle-grid transfers; (2) a mass-weighted L² optimality condition that achieves linear and angular momentum conservation; (3) a mass-orthogonal class of polynomials for rapid solution of projection to the polynomial basis; and (4) a natural treatment of staggered and collocated grids. As examples, the benefits of the disclosed technology is demonstrated in following passages regarding a number of example applications of incompressible flow and material point method (MPM) simulation of elastoplastic materials.

### 2. METHOD OUTLINE AND NOTATION

In some embodiments, the disclosed method is concerned with the update of Lagrangian quantities in PIC simulations. Some notations are introduced herein as example representations. The Lagrangian state associated with a particle p at time tₙ includes mass mₚ, position xₚⁿ, generalized velocity coefficients cₚⁿ and auxiliary quantities Aₚⁿ. Note that the mass does not change with time in accordance with conservation of mass.

In some embodiments, the auxiliary quantities in Aₚⁿ may not be relevant to the particle-grid transfers of the disclosed method, but is included for completeness. For example, in an MPM calculation the deformation gradient Fₚⁿ is auxiliary to transfers and may be included in Aₚⁿ. However, in some embodiments, the disclosed method does not include an update of the auxiliary quantities.

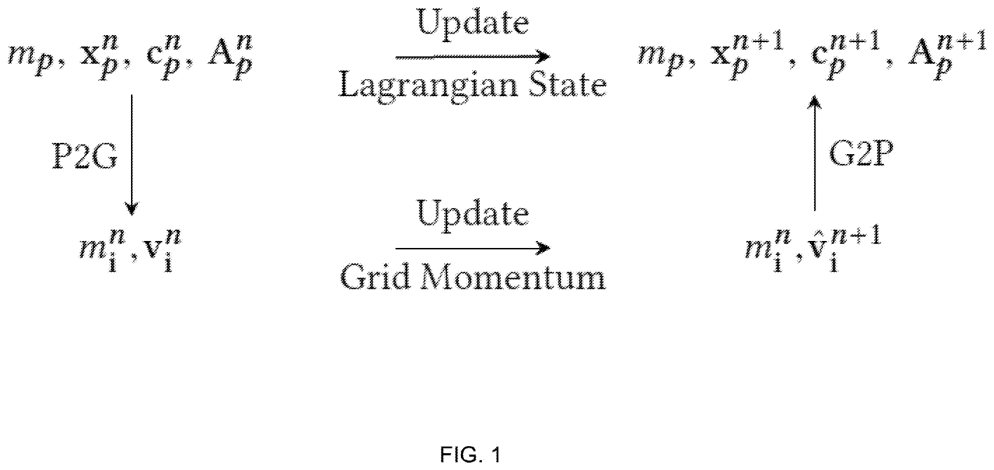

In order to update the Lagrangian state to obtain xₚⁿ⁺¹, cₚⁿ⁺¹ and Aₚⁿ⁺¹, the method transfers mass and momentum from particle to grid (as discussed in section 5.1). The grid momentum is dynamically updated (as discussed in section 5.2). The method transfers the generalized velocity information from grid to particle (as discussed in section 5.3). The method uses the notation mᵢⁿ and vᵢⁿ to denote the mass and velocity transferred to the grid node xᵢ from the particles prior to the grid momentum update. The method further uses the notation \hat{v}ᵢⁿ⁺¹ to denote the grid node velocity that is updated in the grid momentum update. The method uses this convention to distinguish it from vᵢⁿ⁺¹, which is the velocity that is transferred to the grid in the next time step. The method uses xᵢⁿ⁺¹=xᵢ+Δt\hat{v}ᵢⁿ⁺¹ to denote the position of the grid nodes if the nodes move with the grid node velocity \hat{v}ᵢⁿ⁺¹. FIG. 1 illustrates a process of updating the Lagrangian state of the particles of the object and updating grid momentums.

Grid-based interpolating functions N(x−xᵢ) provide the mechanism for the transfer of particle and grid quantities. The grid interpolating functions may be constructed from dyadic products of one-dimensional B-splines. In some embodiments, the method uses the notation wᵢₚⁿ=N(xᵢ−xₚⁿ) to denote the weight of interaction between node xᵢ and particle xₚⁿ.

Note that a particle may interpolate from (N_{B}+1)^{d} grid nodes where N_{B} is the B-spline interpolating order (e.g., 1 for linear, 2 for quadratic, etc.) and d=2 or 3 is the spatial dimension. In other words, the particle with position xₚⁿ may have non-zero weights wᵢₚⁿ for the (N_{B}+/1)^{d} grid nodes most local to it. The method uses the notation [symbol] ₚⁿ⁺¹∈ [symbol] ^{d(N}^{_{B}}¹⁾^{^{d}} to denote the vector of updated grid node velocities

$${\hat{v}}_{{i}_{kp}^{n}}^{n + 1}$$

corresponding to grid nodes xᵢ_{ₖₚ}ⁿ with non-zero weights

$${w}_{{i}_{kp}^{n} p}^{n} .$$

### Thus,

$${\hat{𝒱}}_{p}^{n + 1} = ( \begin{matrix}{\hat{v}}_{{i}_{1 p}^{n}}^{n + 1} \\ {\hat{v}}_{{i}_{2 p}^{n}}^{n + 1} \\ ⋮ \\ {\hat{v}}_{{i}_{( {N}_{B} + 1 ) {d}_{p}}^{n}}^{n + 1}\end{matrix} ) .$$

iₖₚⁿ for k=1, 2, . . . , (N_{B}+1)^{d} an index for nodes with non-zero weights

$${w}_{{i}_{kp}^{n} p}^{n} .$$

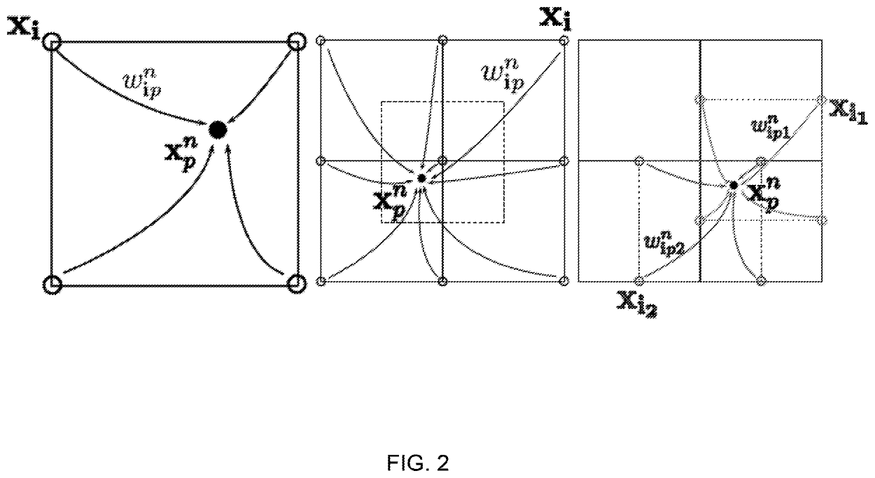

FIG. 2 illustrates an example process of grid interpolation. The weights wᵢₚⁿ and wᵢ_{_{αp}}ⁿ for collocated (left) and Marker-And-Cell (MAC) grids (right) are illustrated. The cases of bilinear (N_{B}=1) and biquadratic (N_{B}=2) are demonstrated in FIG. 2. In either case, the particle interpolates (N_{B}+1)^{d} from grid nodes.

### 3. VELOCITY MODES

The disclosed method augments particles with more general functions, compared to the APIC approach. In APIC, the velocity local to the particle p at time tⁿ is approximated as vₚⁿ(x)=Cₚⁿ(x−xₚⁿ), wherein vₚⁿ is the velocity of the particle and the matrix Cₚⁿ∈ [symbol] ^{d×d} satisfies cₚⁿ=0 for PIC and cₚⁿ is arbitrary for APIC.

In the disclosed method of some embodiments, the particle-wise local velocity is in a form of:

$${v}_{p}^{n} ( x ) = {\sum }_{r = 1}^{{N}_{r}} {\sum }_{α = 1}^{d} {s}_{r} ( {ξ}_{p}^{n} ( x ) - {x}_{p}^{n - 1} ) {e}_{α} {c}_{pr α}^{n} \qquad ( 1 )$$

where the functions sᵣ^{e}_{α}: [symbol] ^{d}→ [symbol] ^{d} are generalized velocity modes,
e_{α}∈ [symbol] ^{d} is the α^{th} standard basis vector and c_{prα}ⁿ are the coefficients of the modes which are stored in the vector cₚⁿ∈ [symbol] ^{dN}^{^{r}}. The generalized velocity modes are built component-by-component in terms of the scalar functions sᵣ: [symbol] ^{d}→ [symbol] . Nᵣ indicates the total number of scalar modes used by the disclosed method of some embodiments.

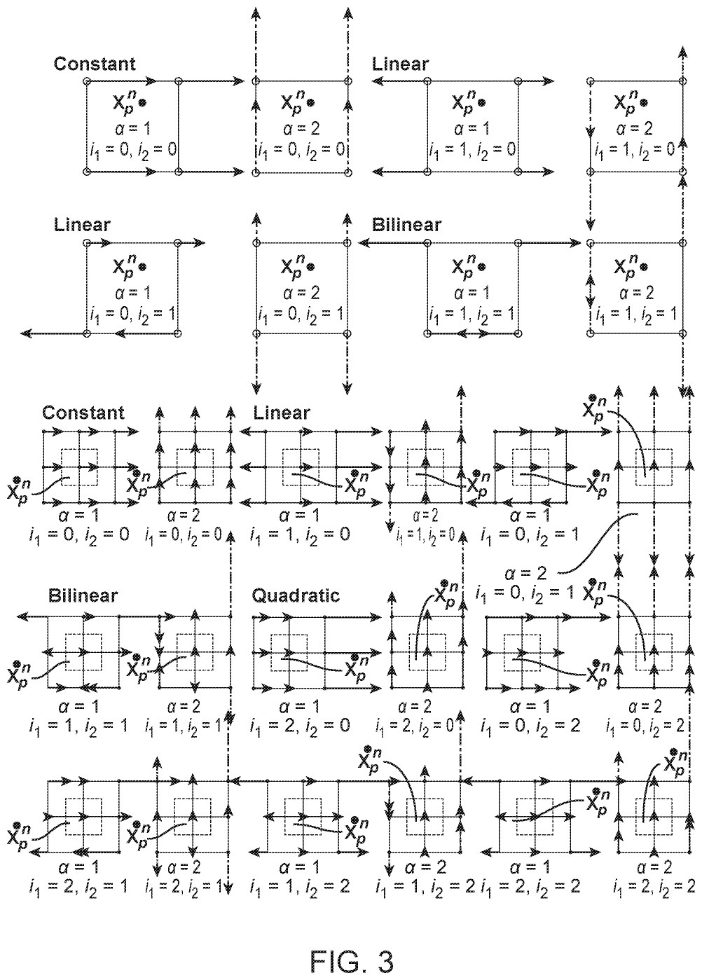

FIG. 3 illustrates the component-wise velocity modes. The component-wise velocity modes from Equation (1) are illustrated in two-dimensions. The top panel shows bilinear interpolation and the bottom panel shows biquadratic interpolation. Constant, linear, bilinear and biquadratic modes are illustrated for x and y components.

The function ξₚⁿ approximates the mapping from the time tⁿ configuration to the time tⁿ⁻¹ configuration local to the particle and represents the advection of the material (as discussed in section 4).

The disclosed method of some embodiments uses polynomial modes:

$$s ( z ) = {\prod }_{β = 1}^{d} {z}_{β}^{{i}_{β}} . \qquad ( 2 )$$

Here z_{β} is the β^{th} component of z∈ [symbol] ^{d}, the term i_{β}∈ [symbol] ⁺ are non-negative integer powers. In some embodiments, the polynomial modes may be modified to ensure a mass orthogonality condition for efficiency in the grid-to-particle transfer (as discussed in section 5.3).

The particle-wise local velocity in Equation (1) is used in the particle-to-grid and grid-to-particle transfers. A particle's contribution to the grid node linear momentum in the particle-to-grid transfer may be specified (as discussed in section 5.1). In the grid-to-particle transfer (as discussed in section 5.3), the coefficients cₚⁿ⁺¹ are chosen so that

$${\hat{v}}_{p}^{n + 1} ( y ) = {\sum }_{r = 1}^{{N}_{r}} {\sum }_{α = 1}^{d} {s}_{r} ( y - {x}_{p}^{n} ) {e}_{α} {c}_{pr α}^{n + 1} \approx {\sum }_{i}^{ } {\hat{v}}_{i}^{n + 1} N ( y - {x}_{i} ) \qquad ( 3 )$$

for y near xₚⁿ. The approximation may be done with points y in the time tⁿ rather than tⁿ⁺¹ configuration of the material. The mapping approximates the advection of the material local to the particle to the time tⁿ⁺¹ configuration.

### 4. UPDATING LAGRANGIAN STATE

Each point X is an initial position of a particle of a material (e.g., an object) in the continuum and ϕ(X,t) is its location at time t. The Lagrangian velocity and acceleration of each particle is

$$V ( X , t ) = \frac{\partial φ}{\partial t} ( X , t ) and A ( X , t ) = \frac{\partial V}{\partial t} ( X , t ) .$$

The Eulerian counterparts may be specified in terms of the inverse of the flow map ϕ⁻¹(⋅,t): Ω^{t}→Ω⁰ via v(x,t)=V(ϕ⁻¹(x,t),t) and a(x,t)=A(ϕ⁻¹(x,t),t) for all x∈Ω^{t}. Here X=ϕ⁻¹(ϕX,t),t) for all particles and for all points x=ϕ(ϕ⁻¹(x,t),t). Also, the Eulerian velocity and acceleration are related through the derivative

$$a ( x , t ) = \frac{Dv}{Dt} ( x , t ) = \frac{\partial v}{\partial t} ( x , t ) + \frac{\partial v}{\partial x} ( x , t ) v ( x , t ) .$$

At time tⁿ the particles have positions xₚⁿ=ϕ(Xₚ, tⁿ). When transferring the state to the grip, grid node approximations to the velocity is obtained via interpolation v(x,tⁿ)=ΣᵢvᵢⁿN(x−xᵢ). The grid momentum update is Langrangian. New grid node velocities \hat{v}ᵢⁿ⁺¹ and their interpolant approximates the updated Lagurangian velocity \hat{v}(y,tⁿ⁺¹)=Σᵢ\hat{v}ᵢⁿ⁺¹N(y−xᵢ).

The time tₙ₊₁ Eulerian velocity is related to the updated Lagrangian velocity through v(x,tⁿ⁺¹)=\hat{v}(ξⁿ⁺¹(x),tⁿ⁺¹). Using ξ|ⁿ⁺¹(x)=ϕ(ϕ⁻¹(x,tⁿ⁺¹),tⁿ) to denote the mapping from the time tⁿ⁺¹ configuration to the time tⁿ configuration. The method can obtain the approximation vₚⁿ⁺¹(x) to v(x,tⁿ⁺¹) given by

ξₚⁿ⁺¹(x)=xₚⁿ+(x−xₚⁿ⁺¹). (4))

Particles move with the interpolated updated Lagrangian velocities in Equation (1) combined with the Equation (4). The updated Lagrangian velocity may be approximated by its components \hat{v}ₚⁿ⁺¹(\hat{x})≈Σᵣ₌₁^{N}^{ᵣ}Σ_{α=1}^{d}sᵣ(\hat{x}−xₚⁿ)e_{α}c_{prα}ⁿ⁺¹ with c_{prα}ⁿ⁺¹ being non-zero for affine modes. Then the system is linear as given by

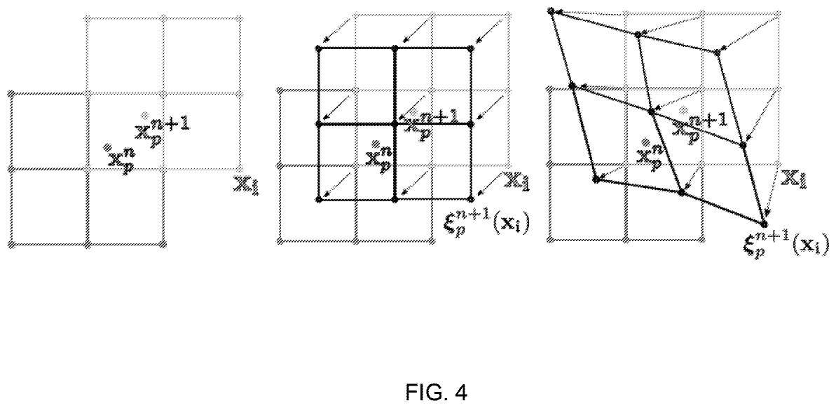

ξₚⁿ⁺¹(x)=xₚⁿ+(I+ΔtCₚⁿ⁺¹)⁻¹(x−xₚⁿ⁺¹) (5)

where Cₚⁿ⁺¹ is the linear part of the affine modes. FIG. 4 illustrates the approximations to ξₚⁿ in Equations (4) and (5) for updating Lagrangian. FIG. 4 illustrates the options for mapping ξₚⁿ⁺¹. As a particle moves from xₚⁿ to xₚⁿ⁺¹, the method may select different grid nodes xᵢ to bi-quadratically interpolate from tⁿ to tⁿ⁺¹. The middle panel shows the approximation of ξₚⁿ⁺¹(xᵢ) from Equation (4) and the right panel from Equation (5).

### 5. TRANSFER AND UPDATE

The process of the disclosed method includes: transferring from particle to grid of mass and linear momentum (section 5.1), updating the grid momentum (5.2), and transferring from grid to particle of generalized velocity coefficients (5.3).

5.1 Transfer from Particle to Grid

The velocity local to the particle from Equation (1) is used to specify the momentum transfer to the grid. Notation (mv)ᵢₚⁿ=mₚwᵢₚⁿvₚⁿ(xᵢ) is used to denote the particle's contribution to the momentum local to the node xᵢ and (mv)ᵢⁿ=Σₚ(mv)ᵢₚⁿ is the total momentum of a grid node from the contribution of all particles.

Similarly, the contribution of the particle's mass to the grid node xᵢ is mᵢₚⁿ=wᵢₚⁿmₚ and the total grid node mass is the sum of the contributions from all particles mᵢⁿ=Σₚmᵢₚⁿ. The method specifies the grid node velocity vᵢⁿ by dividing momentum by mass. The transfer includes:

$${( mv )}_{ip}^{n} = {m}_{ip}^{n} {\sum }_{r = 1}^{{N}_{r}} {\sum }_{α = 1}^{d} {s}_{r} ( {ξ}_{p}^{n} ( {x}_{i} ) - {x}_{p}^{n - 1} ) {e}_{α} {{c}_{pr α}^{n} \\ ( mv )}_{i}^{n} = {\sum }_{p}^{ } {( mv )}_{ip}^{n} , {v}_{i}^{n} = \frac{{( mv )}_{i}^{n}}{{m}_{i}^{n}} .$$

Either local approximation ξₚⁿ(xᵢ) from Equation (4) or (5) can be used.

5.2 Update Grid Momentum

The update of grid momentum can be conducted for, by example, incompressible Euler fluids or elastoplastic solids with MPM. For incompressible Euler fluids:

$${\hat{v}}_{i}^{n + 1} = {v}_{i}^{n} + \frac{Δ t}{ρ} ∇ p , ( Euler \text{/} MAC )$$

$${\hat{v}}_{i}^{n + 1} = {v}_{i}^{n} + \frac{Δ t}{{m}_{i}^{n}} ( f + g ) , ( elastoplastic \text{/} MPM )$$

where f is the elastic force and g is the gravitational acceleration.

5.3 Transfer from Grid to Particle

Transfer from grid to particle can be achieved by choosing the general velocity coefficients cₚⁿ⁺¹ so that the approximation in Equation (3) is optimal in the appropriate sense. The transfer conserves linear and angular momentum and has a diagonal system matrix in the equation for cₚⁿ⁺¹.

The coefficients cₚⁿ⁺¹ can be selected to minimize the mass-weighted distance dₚⁿ(cₚⁿ⁺¹) between local velocities at the grid nodes and the updated grid-node velocities

$$\begin{matrix}{d}_{p}^{n} ( {c}_{p}^{n + 1} ) = {\sum }_{i}^{ } {m}_{ip}^{n} {\vert {\hat{v}}_{i}^{n + 1} - {\hat{v}}_{p}^{n + 1} ( {x}_{i} ) \vert}^{2} \\ = {\sum }_{i}^{ } {m}_{ip}^{n} {\vert {\hat{v}}_{i}^{n + 1} - {\sum }_{r = 1}^{{N}_{r}} {\sum }_{α = 1}^{d} {s}_{r} ( {x}_{i} - {x}_{p}^{n} ) {e}_{α} {c}_{pr α}^{n + 1} \vert}^{2} .\end{matrix}$$

The method uses the notation Qₚⁿ=[Qₚ₁₁ⁿ, Qₚ₁₂ⁿ, . . . , Q_{pN}_{ᵣ}_{d}ⁿ] ∈ [symbol] ^{d(N}^{_{B}}⁺¹⁾^{^{d}}^{×dN}^{ᵣ}, where the columns sᵣ(xᵢ−xₚⁿ)e_{α}Q_{prα}ⁿ of Qₚⁿ are analogous to [symbol] ₚⁿ⁺¹ and have entries equal to the particle-wise local modes at the grid nodes with non-zero weights:

$${𝒬}_{pr α}^{n} = ( \begin{matrix}{s}_{r} ( {x}_{{i}_{1 p}^{n}} - {x}_{p}^{n} ) {e}_{α} \\ {s}_{r} ( {x}_{{i}_{2 p}^{n}} - {x}_{p}^{n} ) {e}_{α} \\ ⋮ \\ {s}_{r} ( {x}_{{i}_{( {N}_{B} + 1 ) {d}_{p}}^{n}} - {x}_{p}^{n} ) {e}_{α}\end{matrix} ) .$$

The optimal coefficients cₚⁿ⁺¹ satisfy

$${c}_{p}^{n + 1} = \begin{matrix}argmin \\ c ∈ {ℝ}^{{dN}_{r}}\end{matrix} {d}_{p}^{n} ( c ) = {( {( {Q}_{p}^{n} )}^{T} {M}_{p}^{n} {Q}_{p}^{n} )}^{- 1} {( {Q}_{p}^{n} )}^{T} {M}_{p}^{n} {\hat{𝒱}}_{p}^{n + 1} \qquad ( 6 )$$

where the matrix Mₚⁿ∈ [symbol] ^{d(N}^{_{B}}¹⁾^{^{d}}^{×d(N}^{_{B}}¹⁾^{^{d}} is diagonal with diagonal entries

$${m}_{{i}_{kp}^{n} p}^{n} .$$

For efficiency, the linear system for coefficients cₚⁿ⁺¹ in Equation (6) can be solved by using properties of the matrix (Qₚⁿ)^{T} MₚⁿQₚⁿ for polynomial velocity modes in Equation (2). The matrix Mₚⁿ is diagonal, as given bar

$${𝒬}_{pr α}^{n} \cdot ( {M}_{p}^{n} {𝒬}_{p t β}^{n} ) = {\sum }_{k}^{ } {m}_{{i}_{kp}^{n} p}^{n} {s}_{r} ( {x}_{{i}_{kp}^{n}} - {x}_{p}^{n} ) {s}_{t} ( {x}_{{i}_{kp}^{n}} - {x}_{p}^{n} ) {e}_{α} \cdot {e}_{β} .$$

Therefore, the matrix entries Q_{prα}ⁿ·(MₚⁿQ_{ptβ}ⁿ)=0 when α≠β. Thus, the coefficient c_{prα}ⁿ are decoupled in α and the matrix (Qₚⁿ)^{T} MₚⁿQₚⁿ can be written as d identical diagonal blocks associated with the dimension-by-dimension velocity modes. The blocks are of the form (Sₚⁿ)^{T} mₚⁿSₚⁿ∈ [symbol] ^{N}^{ᵣ}^{×N}^{ᵣ}, where mₚⁿ∈ [symbol] ^{(N}^{_{B}}⁺¹⁾^{^{d}}^{×(N}^{_{B}}⁺¹⁾^{^{d}} is diagonal with entries

$${m}_{{i}_{kp}^{n} p}^{n}$$

equal to those in Mₚⁿ without the repetition per dimension and sₚⁿ=[sₚ₁ⁿ, . . . , s_{pN}_{ᵣ}ⁿ]∈ [symbol] ^{(N}^{_{B}}⁺¹⁾^{^{d}}^{×N}^{ᵣ}. The columns sₚᵣⁿ∈ [symbol] ^{N}^{_{B}}⁺¹⁾^{^{d}} are analogous to [symbol] ₚⁿ⁺¹ and Q_{prα}ⁿ, but with entries equal to the scalar particle-wise local modes sᵣ(xᵢ−xₚⁿ) at the grid nodes with non-zero weights

$${𝒮}_{pr}^{n} = ( \begin{matrix}{s}_{r} ( {x}_{{i}_{1 p}^{n}} - {x}_{p}^{n} ) \\ {s}_{r} ( {x}_{{i}_{2 p}^{n}} - {x}_{p}^{n} ) \\ ⋮ \\ {s}_{r} ( {x}_{{i}_{( {N}_{B} + 1 ) {d}_{p}}^{n}} - {x}_{p}^{n} )\end{matrix} ) .$$

With the convention, Q_{prα}ⁿ·(MₚⁿQ_{ptβ}ⁿ)=Sₚᵣⁿ·(mₚⁿSₚₜⁿ)e_{α}·e^{β}, the decoupled equations for the optimal coefficients cₚⁿ⁺¹ are given by

$${\sum }_{t = 1}^{{N}_{r}} {𝒮}_{pr}^{n} \cdot ( {m}_{p}^{n} {𝒮}_{p t}^{n} ) {c}_{p t α}^{n + 1} = {𝒬}_{pr α}^{n} \cdot ( {M}_{p}^{n} {\hat{𝒱}}_{p}^{n + 1} ) = {\sum }_{k = 1}^{{( {N}_{B} + 1 )}^{d}} {m}_{{i}_{kp}^{n} p}^{n} {s}_{r} ( {x}_{{i}_{kp}^{n}} - {x}_{p}^{n} ) {\hat{v}}_{{i}_{kp}^{n} α}^{n + 1} \qquad ( 7 )$$

wherein

$${\hat{v}}_{{i}_{kp}^{n} α}^{n + 1}$$

is the α^{th} component of

$${\hat{v}}_{{i}_{kp}^{n}}^{n + 1} .$$

In addition, the individual blocks (Sₚⁿ)^{T} mₚⁿSₚⁿ have sparsity structure. When the grid interpolating function N(x−xᵢ) is multi-linear, N_{B}=1 and (Sₚⁿ)^{T} mₚⁿSₚⁿ is diagonal for Nᵣ≤(N_{B}+1)^{d}=2^{d}. Generally, Nᵣ=(N_{B}+1)^{d} is a natural upper bound on Nᵣ since the minimization in Equation (6) is determined for Nᵣ≤(N_{B}+1)^{d}. Therefore, multi-linear interpolation can have diagonal entries of (S_{P}ⁿ)^{T} mₚⁿSₚⁿ. When the grid interpolating functions are multi-quadratic, N_{B}=2 and (Sₚⁿ)^{T} mₚⁿSₚⁿ is diagonal for Nᵣ≤2^{d} (assuming the multi-linear modes are used, e.g., as in the dictionary ordering of modes based on indexing i_{β} in Equation (2)). However, in general for multi-quadratic with 2^{d}<Nᵣ≤(N_{B}+1)^{d}=3^{d}, (Sₚⁿ)^{T} mₚⁿSₚⁿ is not diagonal.

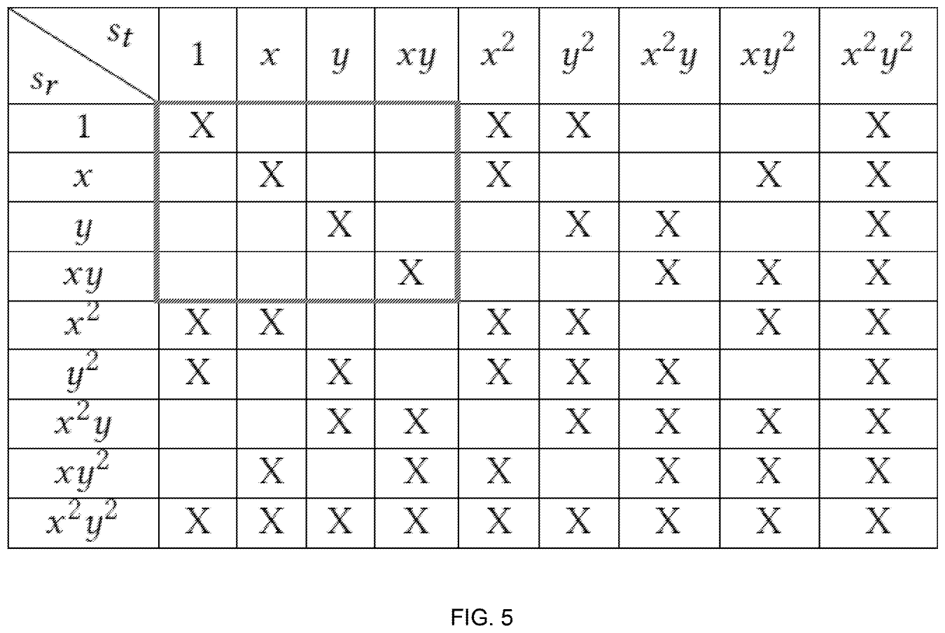

FIG. 5 illustrates a Table 1 for unmodified sparsity pattern with d=2. The sparsity pattern of the matrix (Sₚⁿ)^{T} mₚⁿSₚⁿ for dimension d=2 with scalar modes s=xⁱ^{₁} yⁱ^{₂}. X indicates a non-zero entry in the matrix. Note that the constant, linear, and multi-linear modes (l, x, y, xy) are mass-orthogonal to one another. The multi-quadratic modes couple extensively.

Using a modified Graham-Schmidt approach that takes into account the inner product specified by mₚⁿ, the method can determine modifications to the scalar modes in Equation (2) that lead to a diagonal matrix (Sₚⁿ)^{T} mₚⁿSₚⁿ∈ [symbol] ^{N}^{ᵣ}^{×N}^{ᵣ}. The results of the Graham-Schmidt mass orthogonalization corresponds to replacing z_{β}ⁱ^{_{β}} in Equation (2) with g_{β}(z_{β}) whenever i_{β}=2 where

$${g}_{β} ( w ) = {w}^{2} - \frac{{x}_{p β}^{n} ( Δ {x}^{2} - 4 {( {x}_{p β}^{n} )}^{2} )}{Δ {x}^{2}} w - \frac{Δ {x}^{2}}{4} . \qquad ( 8 )$$

This modification yields a diagonal is (Sₚⁿ)^{T} mₚⁿSₚⁿ.

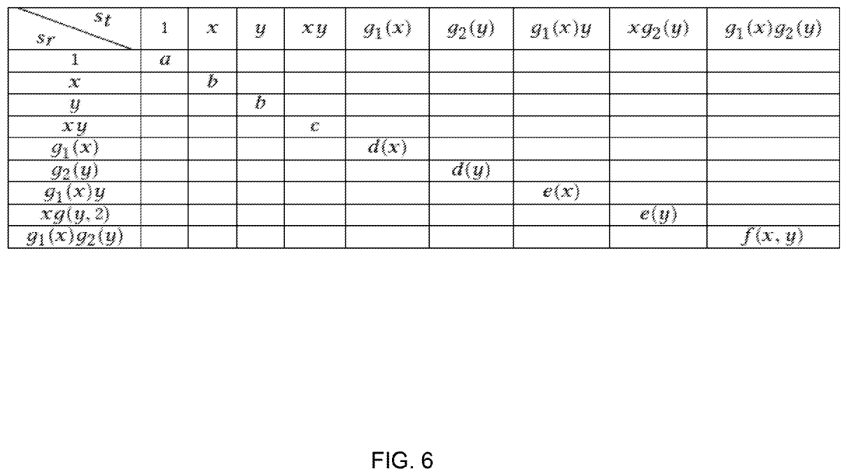

FIG. 6 illustrates a Table 2 showing a modified sparsity pattern of the matrix. The sparsity pattern of the matrix (Sₚⁿ)^{T} mₚⁿSₚⁿ for dimension d=2 with the modified quadratic modes is given by Equation (8), where

$$a = 1 , b = \frac{Δ {x}^{2}}{4} , c = \frac{Δ {x}^{2}}{16} , d ( z ) = \frac{{( Δ {x}^{2} - 4 {z}^{2} )}^{2} ( 3 Δ {x}^{2} - 4 {z}^{2} )}{16 Δ {x}^{2}} , \\ e ( z ) = \frac{{( Δ {x}^{2} - 4 {z}^{2} )}^{2} ( 3 Δ {x}^{2} - 4 {z}^{2} )}{64} , \\ f ( x , y ) = \frac{{( Δ {x}^{2} - 4 {x}^{2} )}^{2} ( 3 Δ {x}^{2} - 4 {x}^{2} ) {( Δ {x}^{2} - 4 {y}^{2} )}^{2} ( 3 Δ {x}^{2} - 4 {y}^{2} )}{256 Δ {x}^{4}} .$$

### 6. MARKER-AND-CELL (MAC) GRID

The method may use i_{α}, 1≤α≤d to denote the face index for each grid. MAC transfers may be performed component-wise. For example, the method may obtain different masses for each grid from mᵢ_{_{α}}ⁿ=mₚⁿN(xᵢ_{_{α}}−xₚⁿ). The component-wise particle-to-grid momentum transfer is

$${( mv )}_{{i}_{a} p}^{n} = {m}_{{i}_{a} p}^{n} {\sum }_{r}^{ } {s}_{r} ( {ξ}_{p}^{n} ( {x}_{{i}_{α}} ) - {x}_{p}^{n - 1} ) {{c}_{pr α}^{n} \\ ( mv )}_{{i}_{α}}^{n} = {\sum }_{p}^{ } {( mv )}_{{i}_{α} p}^{n} , {v}_{{i}_{α}}^{n} = \frac{{( mv )}_{{i}_{α}}^{n}}{{m}_{{i}_{α}}^{n}} .$$

The method may use the expression for ξₚⁿ from Equation (4).

The transfers from grid to particle are performed component-wise since as discussed in section 5.3, the system in Equation (7) decouples component-wise. However, the mass matrix

$$( {m}_{p α}^{n} , {m}_{{i}_{kp α}^{n} p α}^{n} )$$

and scalar mode vectors (S_{ptα}ⁿ) may be different on each of the velocity face grids, which may be accounted for as given by

$${\sum }_{t = 1}^{{N}_{r}} {𝒮}_{pr α}^{n} \cdot ( {m}_{p α}^{n} {𝒮}_{p t α}^{n} ) {c}_{p t α}^{n + 1} = {\sum }_{k = 1}^{{( {N}_{B} + 1 )}^{d}} {m}_{{i}_{kp α}^{n} p α}^{n} {s}_{r} ( {x}_{{i}_{kp α}^{n}} - {x}_{p}^{n} ) {\hat{v}}_{{i}_{kp α}^{n} α}^{n + 1} .$$

### 7. EXAMPLE SIMULATION RESULTS

7.1 Incompressible Flow

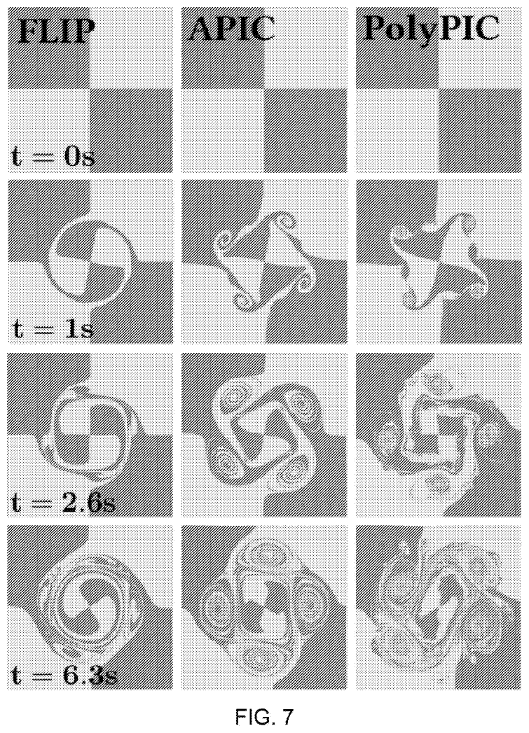

FIG. 7 illustrates a simulation of vortex sheets by setting the velocity inside a circle to be initially rotating relative to a stationary surrounding fluid. The discontinuity in the velocity induces vorticity at the interface which produces intricate flow patterns. The disclosed PolyPIC method is compared with FLIP and APIC for resolving the vortical flow.

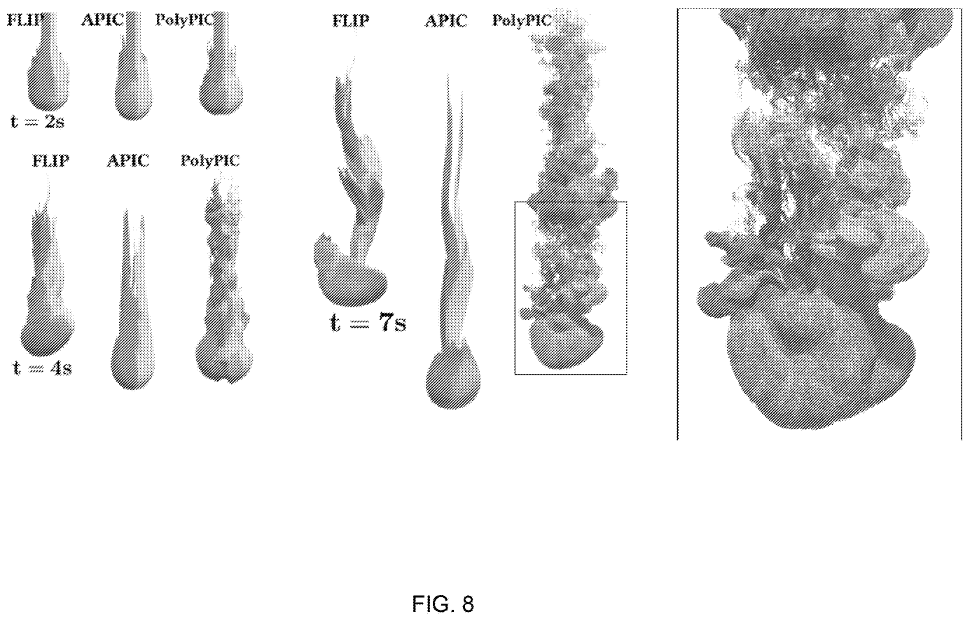

FIG. 8 illustrates a simulation of an ink droplet in an ambient incompressible fluid by dropping liquid onto a free surface. The particles are rendered in the ink. Note that the ink and water are both simulated as the same incompressible fluid. The PolyPIC method is compared to FLIP and APIC for capturing the transition to turbulence. PolyPIC performs well even when the grid resolution is rather low. The grid resolution is, for example, 64×256×64. The PolyPIC method as illustrated uses, for example, 8 simulated particles per cell, and 8000 passively advected tracer particles per cell in a post-process for visualization.

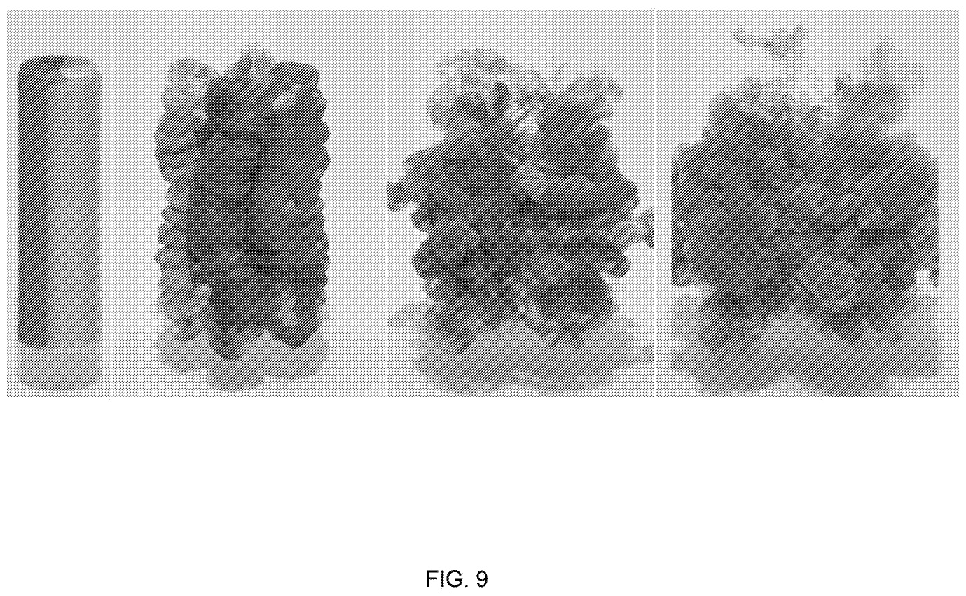

FIG. 9 illustrates a 3D simulation of a rotating column of colored dust. The cylinder is initially rotating about its axis relative to a stationary ambient fluid. The resolution grid is, for example, 88×132×88 with 8 simulated particles per cell for simulation and 216 passively advected tracer particles per cell in a post-process for visualization. Despite the relatively low resolution simulation, intricate flow patterns are observed.

8.2 MPM Elastoplaticity

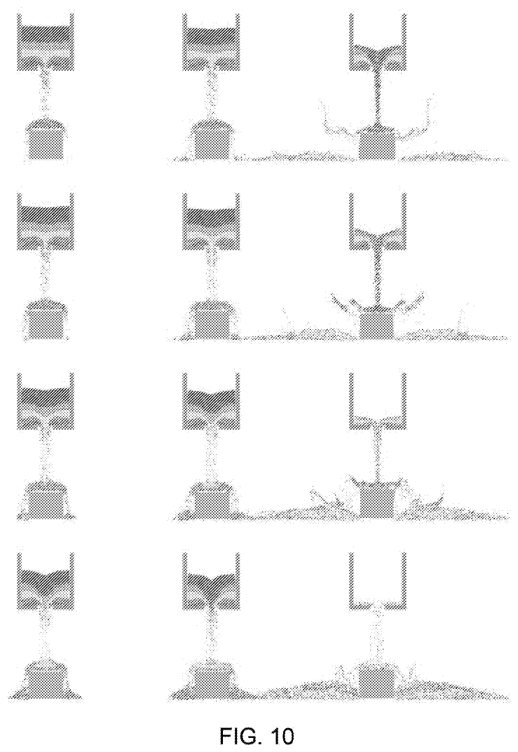

FIG. 10 illustrates a simulation of sand demonstrating an increasingly energetic nature of elastoplasticity simulations with disclosed polynomial modes. Rainbow colored sands are poured onto an elastic jello square. APIC and PolyPIC (from left to right) with Nᵣ=4 and Nᵣ=6 modes are shown. Increasing degrees of PolyPIC allow for more energetic sand flowing and jello bouncing. In particular, with Nᵣ=6 modes the sand flows more freely and splashes off the jello more dramatically, while the jello bounces more readily.

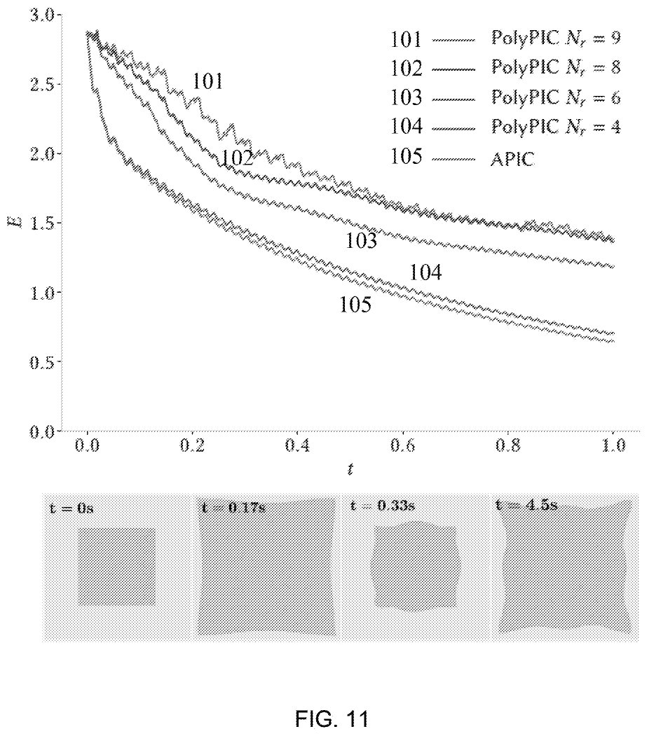

FIG. 11 illustrates an improved energy conservation of the disclosed method. The total energy as a function of time is plotted for an elastic square with initial compressive dilation. The energy is calculated as the sum of the elastic potential energy on the particles and the kinetic energy on the grid. In this scenario, a two-dimensional (2D) hyperelastic square is initially compressed. The total energy of the system may be conserved with these initial and boundary conditions (zero traction). With the polynomial modes, the energy conservation improves.

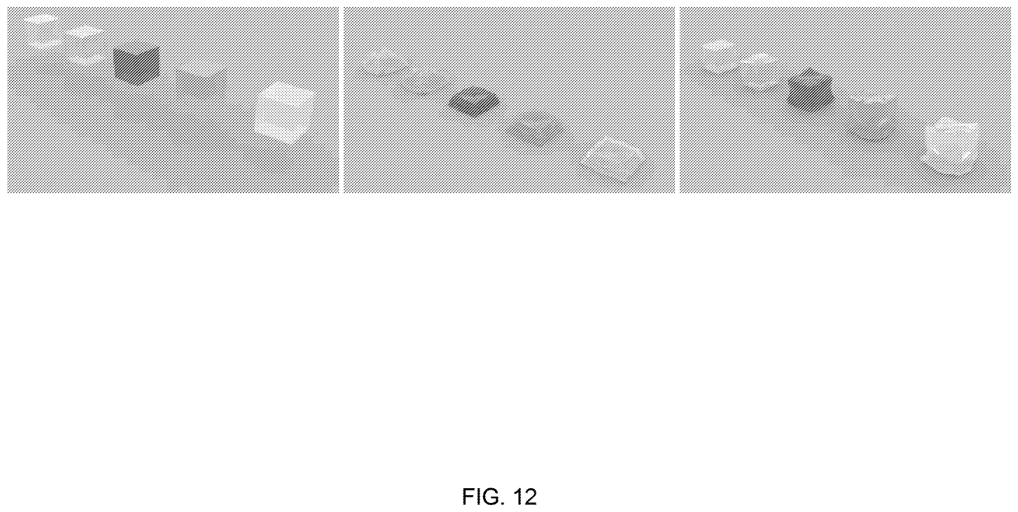

FIG. 12 illustrates how the increased energy retention affects the dynamics of a jello dropped on the ground. From left to right are APIC, PolyPIC with Nᵣ=8, Nᵣ=11, Nᵣ=14, and Nᵣ=18. FIG. 12 shows that compared to APIC, PolyPIC better conserves total energy which results in less numerical damping of the deformable motion.

### 9. HARDWARE ARCHITECTURE

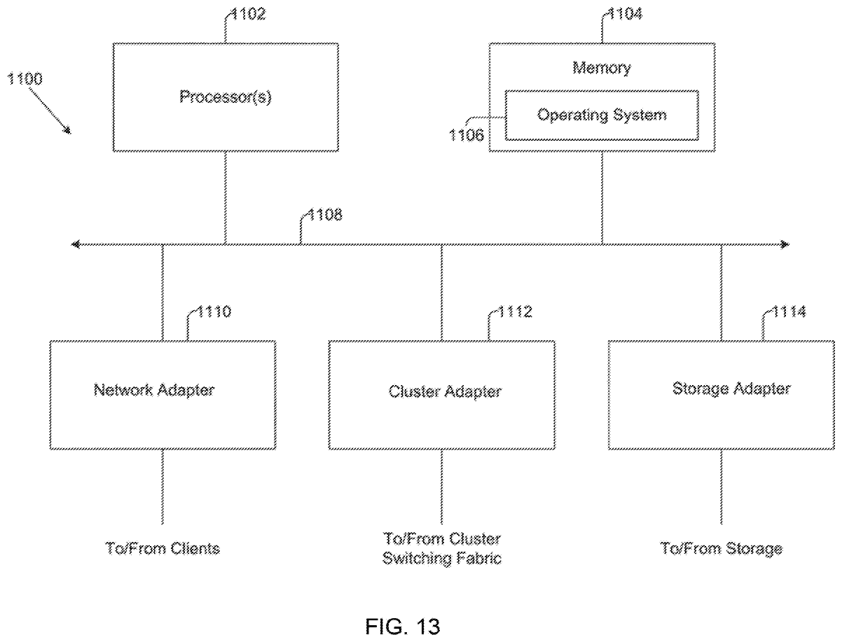

FIG. 13 is a high-level block diagram illustrating an example of a hardware architecture of a computing device 1100 that may perform various processes as disclosed, according to various embodiments of the present disclosure. The computing device 1100 may execute some or all of the processor-executable operations described herein. In various embodiments, the computing device 1100 includes a processor subsystem that includes one or more processors 1102. The processor 1102 may be or may include, one or more programmable general-purpose or special-purpose microprocessors, digital signal processors (DSPs), programmable controllers, application specific integrated circuits (ASICs), programmable logic devices (PLDs), or the like, or a combination of such hardware based devices.

The computing device 1100 can further include a memory 1104, a network adapter 1110, a cluster access adapter 1112 and a storage adapter 1114, all interconnected by an interconnect 1108. The interconnect 1108 may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other data communication interconnect.

The cluster access adapter 1112 includes one or more ports adapted to couple the computing device 1100 to other devices. In the illustrated embodiment, Ethernet can be used as the clustering protocol and interconnect media, although other types of protocols and interconnects may be utilized within the cluster architecture described herein.

The computing device 1100 can be embodied as a single- or multi-processor storage system executing a storage operating system 1106 that can implement a high-level module, for example, a storage manager, to logically organize the information as a hierarchical structure of named directories and files at the memory 1104. The computing device 1100 can further include graphical processing unit(s) for graphical processing tasks or processing non-graphical tasks in parallel.

The memory 1104 can comprise storage locations that are addressable by the processor(s) 1102 and adapters 1110, 1112, and 1114 for storing processor-executable code or instructions and data structures. The processor 1102 and adapters 1110, 1112, and 1114 may, in turn, comprise processing elements and/or logic circuitry configured to execute the software code and manipulate the data structures. The operating system 1106, portions of which are typically resident in the memory 1104 and executed by the processors(s) 1102, functionally organizes the computing device 1100 by (among other things) configuring the processor(s) 1102 to invoke the operating system 1106. It will be apparent to those skilled in the art that other processing and memory implementations, including various non-transitory computer-readable storage media, may be used for storing and executing program instructions pertaining to the disclosed technology.

The network adapter 1110 can include multiple ports to couple the computing device 1100 to one or more clients over point-to-point links, wide area networks, virtual private networks implemented over a public network (e.g., the Internet) or a shared local area network. The network adapter 1110 thus can include mechanical, electrical and signaling circuitry to connect the computing device 1100 to a network. Illustratively, the network can be embodied as an Ethernet network or a Fiber Channel (FC) network. A client can communicate with the computing device 1100 over the network by exchanging discrete frames or packets of data according to pre-defined protocols, such as TCP/IP.

The storage adapter 1114 can cooperate with the storage operating system 1106 to access information requested by a client. The information may be stored on any type of attached array of writable storage media, such as magnetic disk or tape, optical disk (e.g., CD-ROM or DVD), flash memory, solid-state disk (SSD), electronic random access memory (RAM), micro-electro mechanical and/or any other similar media adapted to store information, including data and parity information. The storage adapter 1114 can include multiple ports having input/output (I/O) interface circuitry that couples to disks over an I/O interconnect arrangement, such as a high-performance, FC link topology. In various embodiments, the cluster adapter 1112 and the storage adapter 1114 can be implemented as one adaptor configured to connect to a switching fabric, such as a storage network switch, in order to communicate with other devices and mass storage devices.

Amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A method of rendering an animated object, comprising:
determining momentums of a plurality of particles of the object as sums of polynomials;
transferring the momentums of the particles of the object to a grid including a plurality of grid nodes;
updating momentums of the grid nodes based on the transferred momentums of the particles;
transferring the updated momentums of the grid nodes to the particles of the object;
updating positions of the particles based on the updated momentums of the grid nodes; and
outputting a visualization of the object based on the updated positions of the particles of the object.

2. The method of claim 1, wherein the polynomials include a plurality of component-wise velocity modes.

3. The method of claim 2, wherein the component-wise velocity modes include a constant velocity mode.

4. The method of claim 2, wherein the component-wise velocity modes include a linear velocity mode.

5. The method of claim 2, wherein the component-wise velocity modes include a multi-linear velocity mode.

6. The method of claim 2, wherein the component-wise velocity modes include a multi-quadratic velocity mode.

7. The method of claim 1, wherein kinetic energies are conserved when the momentums of the particles of the object are transferred to the grid.

8. The method of claim 1, wherein the polynomials having a polynomial basis which is mass-orthogonal.

9. The method of claim 1, further comprising:
specifying a next time step; and
repeating at the next time step the transferring momentums of the particles of the object, the updating momentums of the grid nodes, and the transferring the updated momentums of the grid nodes.

10. A non-transitory computer-readable storage medium storing a program to render an animated object, the program comprising instructions executable by a processor to:
represent the object using a plurality of particles;
transfer momentums of the particles to a grid representation of the object, the grid representation including a plurality of grid nodes;
update momentums of the grid nodes based on the transferred momentums of the particles;
transfer the updated momentums of the grid nodes to the particles, by interpolation of mass-orthogonal polynomial velocity modes;
determine updated positions of the particles based on the transferred momentums of the grid nodes; and
update a visualization of the object based on the updated positions of the particles.

11. The non-transitory computer-readable storage medium of claim 10, wherein the polynomial velocity modes include a constant velocity mode.

12. The non-transitory computer-readable storage medium of claim 10, wherein the polynomial velocity modes include a linear velocity mode.

13. The non-transitory computer-readable storage medium of claim 10, wherein the polynomial velocity modes include a multi-linear velocity mode.

14. The non-transitory computer-readable storage medium of claim 10, wherein the polynomial velocity modes include a multi-quadratic velocity mode.
